(19) United States
(12) Patent Application Publication
(10) Pub. No.: US 2019/0262927 A1
(43) Pub. Date: Aug. 29, 2019

(54) PULSED ARC WELDING METHOD

(71) Applicant: TOYOTA JIDOSHA KABUSHIKI KAISHA, Toyota-shi (JP)

(72) Inventors: Yoshihiro IWANO, Toyota-shi (JP); Kenichiro NAKASHIMA, Toyota-shi (JP)

(73) Assignee: TOYOTA JIDOSHA KABUSHIKI KAISHA, Toyota-shi (JP)

(21) Appl. No.: 16/239,571

(22) Filed: Jan. 4, 2019

(30) Foreign Application Priority Data
Feb. 28, 2018 (JP) 2018-034698

(51) Int. Cl. B23K 9/09; B23K 9/095; B23K 9/167; B23K 9/173

(52) U.S. Cl. CPC B23K 9/092; B23K 9/1735; B23K 9/1675; B23K 9/0953

(57) ABSTRACT

The pulsed arc welding method supplies a pulsed current to a welding electrode and performs welding while the welding electrode is relatively moved with respect to a workpiece 40. The welding electrode includes a main electrode 13 and a sub electrode 23. The sub electrode 23 is arranged on the back side of the main electrode 13 in the moving direction, the sub electrode 23 is moved along with the main electrode 13 above a molten pool 41 formed by the main electrode 13, and a second pulsed current P2 that is asynchronous with a first pulsed current P1 to be supplied to the main electrode 13 is supplied to the sub electrode 23.

### CROSS REFERENCE TO RELATED APPLICATIONS

This application is based upon and claims the benefit of priority from Japanese patent application No. 2018-034698, filed on Feb. 28, 2018, the disclosure of which is incorporated herein in its entirety by reference.

### BACKGROUND

The present disclosure relates to a pulsed arc welding method.

A pulsed arc welding method that supplies a pulsed current to a consumable or non-consumable welding electrode has been known. By controlling a droplet transfer of the consumable welding electrode or the state of a molten pool, occurrence of, for example, welding defects such as blowholes can be reduced.

Incidentally, as disclosed in Japanese Unexamined Patent Application Publication No. 2011-140071, an arc welding method that uses two consumable welding electrodes for one molten pool has been known.

### SUMMARY

The present inventors have found the following problems regarding the pulsed arc welding method.

There is a problem that, while gas which causes blowholes is easily discharged in the vicinity of a part of the molten pool immediately under the welding electrode, this gas is not easily discharged in a part of the molten pool away from the welding electrode. On the back side of the welding electrode in the molten pool in a direction in which the welding electrode moves, in particular, air bubbles trapped in the vicinity of the surface of the molten pool are not easily discharged, and tend to remain as blowholes. Even when two welding electrodes are simply used for one molten pool as disclosed in Japanese Unexamined Patent Application Publication No. 2011-140071, it is impossible to sufficiently reduce the occurrence of blowholes.

The present disclosure has been made in view of the aforementioned circumstances and provides a pulsed arc welding method capable of reducing blowholes.

A pulsed arc welding method according to one aspect of the present disclosure is a pulsed arc welding method in which a pulsed current is supplied to a welding electrode and welding is performed while the welding electrode is relatively moved with respect to a workpiece, in which

the welding electrode includes a main electrode and a sub electrode,

the sub electrode is arranged on the back side of the main electrode in the moving direction and the sub electrode is moved along with the main electrode above a molten pool formed by the main electrode, and

a second pulsed current asynchronous with a first pulsed current to be supplied to the main electrode is supplied to the sub electrode.

In the pulsed arc welding method according to one aspect of the present disclosure, the sub electrode is arranged on the back side of the main electrode in the moving direction, the sub electrode is moved along with the main electrode above the molten pool formed by the main electrode, and the second pulsed current asynchronous with the first pulsed current to be supplied to the main electrode is supplied to the sub electrode. Accordingly, on the back side of the molten pool, it is possible to generate the arc from the sub electrode at a timing different from the timing when the arc is generated from the main electrode, and to rupture the air bubbles trapped in the vicinity of the surface of the molten pool. As a result, gas which causes blowholes is discharged from the molten pool and blowholes can be reduced.

Each of the main electrode and the sub electrode may be a consumable welding electrode. It is possible to reduce blowholes more definitely.

Further, even in a case in which the main electrode is a consumable welding electrode and the sub electrode is a non-consumable welding electrode, blowholes can be reduced.

The workpiece may include a die-cast member made of aluminum alloy. When the workpiece includes a die-cast member, water vapor tends to remain inside therein during casting and blowholes easily occur during welding. Therefore, the effect of reducing blowholes is large.

According to the present disclosure, it is possible to provide a pulsed arc welding method capable of reducing blowholes.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic view showing a pulsed arc welding method and a structure of a pulsed arc welding apparatus used in the pulsed arc welding method according to a first embodiment;

FIG. 2 is a timing chart showing one example of a pulsed current P1 to be supplied to an electrode wire 13 and a pulsed current P2 to be supplied to an electrode wire 23;

FIG. 3 is a schematic plan view of a welded specimen according to a comparative example and an Example;

FIG. 4 is a timing chart showing the pulsed current P1 supplied to the electrode wire 13 and the pulsed current P2 supplied to the electrode wire 23 in the Example;

FIG. 5 shows X-ray transmission images showing generation status of air bubbles in a molten pool 41 during welding; and

FIG. 6 shows macro photographs showing generation status of blowholes in cross sections A and B of the welded specimen shown in FIG. 3.

### DESCRIPTION OF EMBODIMENTS

Hereinafter, specific embodiments of the disclosure will be described in detail with reference to the accompanying drawings. However, the disclosure is not limited to the embodiments. For the purpose of clear explanation, the following description and the drawings are appropriately simplified.

### First Embodiment

### <Pulsed Arc Welding Method and Pulsed Arc Welding Apparatus Used Therefor>

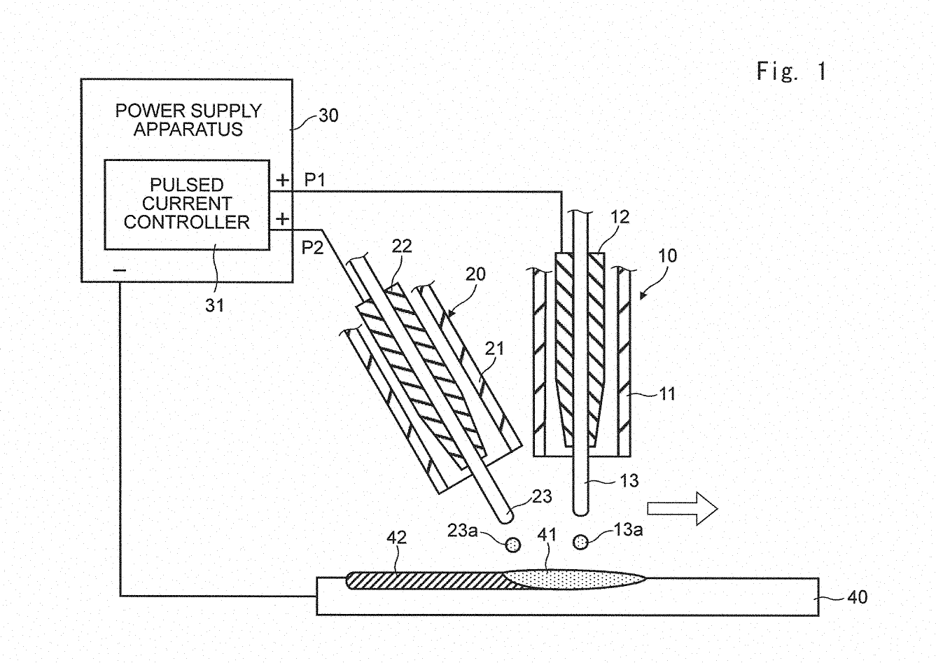

Referring first to FIG. 1, a pulsed arc welding method and a pulsed arc welding apparatus used for the pulsed arc welding method according to a first embodiment will be explained. FIG. 1 is a schematic view showing a pulsed arc welding method and a structure of a pulsed arc welding apparatus used for the pulsed arc welding method according to the first embodiment.

While the pulsed arc welding apparatus shown in FIG. 1 is a Metal Inert Gas (MIG) welding apparatus that uses a consumable welding electrode, this apparatus is not limited thereto. The pulsed arc welding apparatus shown in FIG. 1 may be, for example, a Tungsten Inert Gas (TIG) welding apparatus that uses a non-consumable welding electrode.

As shown in FIG. 1, the pulsed arc welding apparatus used for the pulsed arc welding method according to the first embodiment includes a main torch 10, a sub torch 20, and a power supply apparatus 30. In the example shown in FIG. 1, bead-on-plate welding is performed by this pulsed arc welding apparatus, and a linear welding bead 42 is formed on the upper surface of a plate-shaped workpiece 40.

The workpiece 40 is, for example, a die-cast member made of aluminum alloy, but is not limited thereto. When a die-cast member is used, water vapor tends to remain inside therein during casting and thus blowholes tend to occur during welding.

As a matter of course, the pulsed arc welding method according to the first embodiment can be applied not only to the bead-on-plate welding but also to joint welding or other types of welding.

As shown in FIG. 1, the main torch 10 has a structure in which a cylindrical contact chip 12 into which an electrode wire (main electrode) 13 is inserted is coated with a cylindrical nozzle 11. The tip part of the electrode wire 13 is protruded from the tip of the nozzle 11. Inert gas such as argon gas flows inside the nozzle 11 toward the tip of the nozzle 11.

Further, the electrode wire 13 is sequentially fed toward the workpiece 40 while contacting the contact chip 12. The contact chip 12 is made of, for example, copper or copper alloy, and is electrically connected to the power supply apparatus 30. Therefore, a pulsed current (a first pulsed current) P1 is supplied from the power supply apparatus 30 to the electrode wire 13 via the contact chip 12.

When the pulsed current P1 is supplied to the electrode wire 13, an arc occurs, and thus the tip of the electrode wire 13 is melted to become a droplet 13a and falls into a molten pool 41 formed on the upper surface of the workpiece 40. For example, in the one drop per pulse control, one droplet 13a is generated for each pulsed current P1. The molten pool 41 is formed by the arc injected from the main torch 10.

While the electrode wire 13 is a consumable welding electrode as described above, a main electrode of a non-consumable welding electrode may be used in place of the electrode wire 13.

The sub torch 20 includes a structure similar to that of the main torch 10. Specifically, as shown in FIG. 1, the sub torch 20 includes a structure in which a cylindrical contact chip 22 into which an electrode wire (sub electrode) 23 is inserted is coated with a cylindrical nozzle 21. The tip part of the electrode wire 23 is protruded from the tip of the nozzle 21. Inert gas such as argon gas flows toward the tip of the nozzle 21 inside the nozzle 21.

Further, the electrode wire 23 is sequentially fed toward the workpiece 40 while contacting the contact chip 22. The contact chip 22 is made of, for example, copper or copper alloy, and is electrically connected to the power supply apparatus 30. Therefore, a pulsed current (a second pulsed current) P2 is supplied from the power supply apparatus 30 to the electrode wire 23 via the contact chip 22.

When the pulsed current P2 is supplied to the electrode wire 23, an arc occurs, and thus the tip of the electrode wire 23 is melted to become a droplet 23a and falls into the molten pool 41 formed on the upper surface of the workpiece 40. For example, in the one drop per pulse control, one droplet 23a is generated for each pulsed current P2. It is possible to discharge gas which causes blowholes from the molten pool 41 by the arc injected from the sub torch 20, the details of which will be explained later.

While the electrode wire 23 is a consumable welding electrode, as described above, a sub electrode of a non-consumable welding electrode may be used in place of the electrode wire 23.

As shown in FIG. 1, the sub torch 20 is arranged on the back side of the main torch 10 in the moving direction shown by an outline arrow in FIG. 1. The sub torch 20 moves along with the main torch 10 above the molten pool 41. That is, the molten pool 41 also moves in the direction of the outline arrow along with the main torch 10 and the sub torch 20. In this case, the back end of the molten pool 41 in the moving direction is sequentially solidified, and the welding bead 42 is thus formed. In this way, the welding bead 42 is extended as the molten pool 41 moves in the direction of the outline arrow.

Instead of the main torch 10 and the sub torch 20, the workpiece 40 may be moved. That is, it is sufficient that the main torch 10 and the sub torch 20 be relatively moved with respect to the workpiece 40.

As shown in FIG. 1, the power supply apparatus 30 includes a pulsed current controller 31. The pulsed current controller 31 controls the pulsed current P1 to be supplied to the electrode wire 13 of the main torch 10. In a similar way, the pulsed current controller 31 controls the pulsed current P2 to be supplied to the electrode wire 23 of the sub torch 20. Each of the electrode wires 13 and 23 is connected to a positive electrode terminal of the power supply apparatus 30 and the workpiece 40 is connected to a negative electrode terminal of the power supply apparatus 30.

The pulsed current controller 31 includes an operation unit such as a Central Processing Unit (CPU), and a storage unit such as a Random Access Memory (RAM) or a Read Only Memory (ROM) that stores various control programs, data and the like, although they are not shown in the drawings.

Each of the electrode wires 13 and 23 may instead be connected to the negative electrode terminal of the power supply apparatus 30 and the workpiece 40 may instead be connected to the positive electrode terminal of the power supply apparatus 30.

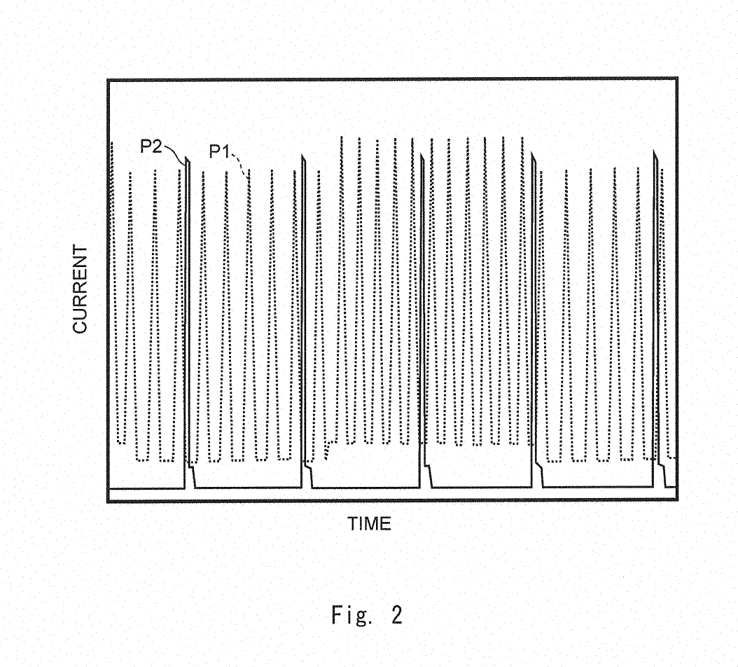

In the following description, with reference to FIG. 2, a method of controlling the pulsed currents P1 and P2 by the pulsed current controller 31 will be explained. FIG. 2 is a timing chart showing one example of the pulsed current P1 to be supplied to the electrode wire 13 and the pulsed current P2 to be supplied to the electrode wire 23. The horizontal axis in FIG. 2 indicates time and the vertical axis in FIG. 2 indicates the current. As shown in FIG. 2, the pulsed currents P1 and P2 are controlled by the pulsed current controller 31 in such a way that the pulsed current P2 to be supplied to the electrode wire 23 of the sub torch 20 becomes asynchronous with the pulsed current P1 to be supplied to the electrode wire 13 of the main torch 10.

In the example shown in FIG. 2, since the electrode wire 23 of the sub torch 20 is a consumable welding electrode, the pulse interval of the pulsed current P2 is longer than the pulse interval of the pulsed current P1. If the electrode of the sub torch 20 is a non-consumable one, the pulse interval of the pulsed current P2 may be equal to or smaller than the pulse interval of the pulsed current P1. However, the shorter the pulse interval of the pulse current P2 becomes, the more power consumption can be suppressed.

While the pulsed currents P1 and P2 shown in FIG. 2 are DC pulses, they may instead be AC pulses.

As described above, the sub torch 20 is arranged on the back side of the main torch 10 in the moving direction (hereinafter this side is also simply referred to as a “back side”). Therefore, on the back side of the molten pool 41 that is to be solidified, an arc occurs from the sub torch 20 at a timing different from the timing when the arc is generated from the main torch 10, and the droplet 23a falls into the molten pool 41. As a result, on the back side of the molten pool 41, the temperature of the molten pool 41 increases as a current flows on the surface of the molten pool 41 and this surface oscillates, and thus air bubbles trapped in the vicinity of the surface of the molten pool 41 are ruptured.

Accordingly, compared to the case in which the sub torch 20 is not used and only the main torch 10 is used, in the above case where both the main torch 10 and the sub torch 20 are used, more gas which causes blowholes is discharged from the molten pool 41 and the occurrence of blowholes can be more reduced. When only the main torch 10 is used as in related art, air bubbles trapped in the vicinity of the surface of the molten pool 41 on the back side of the molten pool 41 are not easily discharged and thus these air bubbles tend to remain as blowholes.

As described above, in the pulsed arc welding method according to this embodiment, the sub torch 20 is arranged on the back side of the main torch 10 in the moving direction, and the sub torch 20 is moved along with the main torch 10 above the molten pool 41 formed by the main torch 10. Then the pulsed current P2 which is asynchronous with the pulsed current P1 is supplied to the sub torch 20.

Therefore, on the back side of the molten pool 41, an arc is generated from the sub torch 20 at a timing different from the timing when the arc is generated from the main torch 10, whereby it is possible to rupture the air bubbles trapped in the vicinity of the surface of the molten pool 41. As a result, compared to the case in which only the main torch 10 is used, more gas which causes blowholes is discharged from the molten pool 41 and the occurrence of blowholes can be more reduced.

### EXAMPLE

In the following description, the pulsed arc welding method according to the first embodiment will be explained in detail with a comparative example and an Example. However, the pulsed arc welding method according to the first embodiment is not limited to the following Example. In the following description as well, the pulsed arc welding apparatus shown in FIG. 1 will be referred to as appropriate.

### Test Conditions

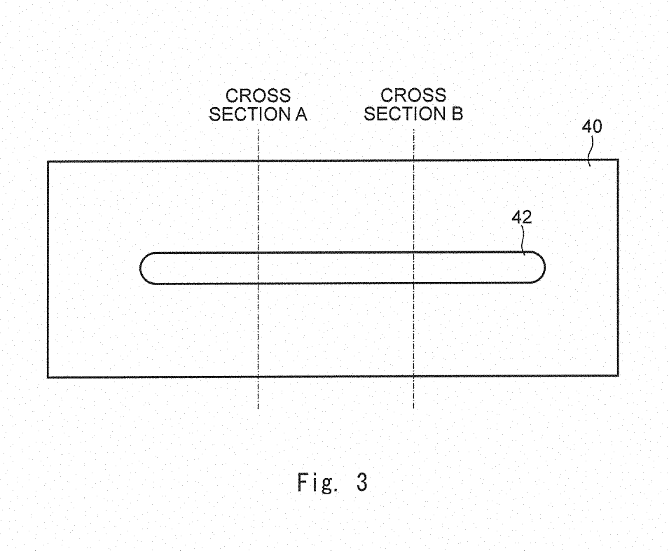

First, common test conditions in the comparative example and the Example will be explained. FIG. 3 is a schematic plan view of a welded specimen according to the comparative example and the Example. As shown in FIG. 3, in the comparative example and the Example, the linear welding bead 42 was formed on the upper surface of the plate-shaped workpiece 40, which is a die-cast member made of aluminum alloy using the pulsed arc welding apparatus shown in FIG. 1. The generation status of air bubbles in the molten pool 41 during welding was recorded and checked using X-ray transmission observation. Further, the generation status of blowholes in cross sections A and B of the welded specimen shown in FIG. 3 was checked by macro photograph observation. There is no special meaning regarding the positions of the cross sections A and B, and the macro photograph observation was simply performed in two different positions.

The diameter of the nozzle 11 of the main torch 10 and that of the nozzle 21 of the sub torch 20 were each set to 12 mm. Argon gas with a flow rate of 15 L/min was made to flow inside the nozzle 11 of the main torch 10 and the nozzle 21 of the sub torch 20.

Each of the welding speed in the comparative example and that in the Example was 10 mm/s.

### (Test Conditions According to Comparative Example)

Next, test conditions in the pulsed arc welding method according to the comparative example will be explained. In the comparative example, in the pulsed arc welding apparatus shown in FIG. 1, welding was performed using only the main torch 10, not using the sub torch 20.

A DC low-frequency superimposed pulse controlled to be one drop per pulse was used as the pulsed current P1 to be supplied to the main torch 10. The frequency in the low frequency to be superimposed was set to 7 Hz. The feed speed of the electrode wire 13 was set to 9.5 m/min, the average welding current was set to 152 A, and the arc voltage was set to 23.2 V.

### (Test Conditions According to Example)

Next, test conditions in the pulsed arc welding method according to the Example will be explained. In this Example, in the pulsed arc welding apparatus shown in FIG. 1, welding was performed using both the main torch 10 and the sub torch 20.

A DC low-frequency superimposed pulse controlled to be one drop per pulse was used as the pulsed current P1 to be supplied to the main torch 10, similar to the comparative example. The frequency in the low frequency to be superimposed was set to be 7 Hz as well. The feed speed of the electrode wire 13 was set to 8.0 m/min, the average welding current was set to 127 A, and the arc voltage was set to 22.1 V.

A DC standard pulse controlled to be one drop per pulse was used as the pulsed current P2 to be supplied to the sub torch 20. The feed speed of the electrode wire 23 was set to 1.5 m/min, the average welding current was set to 20 A, and the arc voltage was set to 18.5 V. The feed speed of the electrode wire 13 in the comparative example, which was set to 9.5 m/min, corresponded to the total of the feed speed of the electrode wire 13, which was 8.0 m/min, and the feed speed of the electrode wire 23, which was 1.5 m/min in the Example.

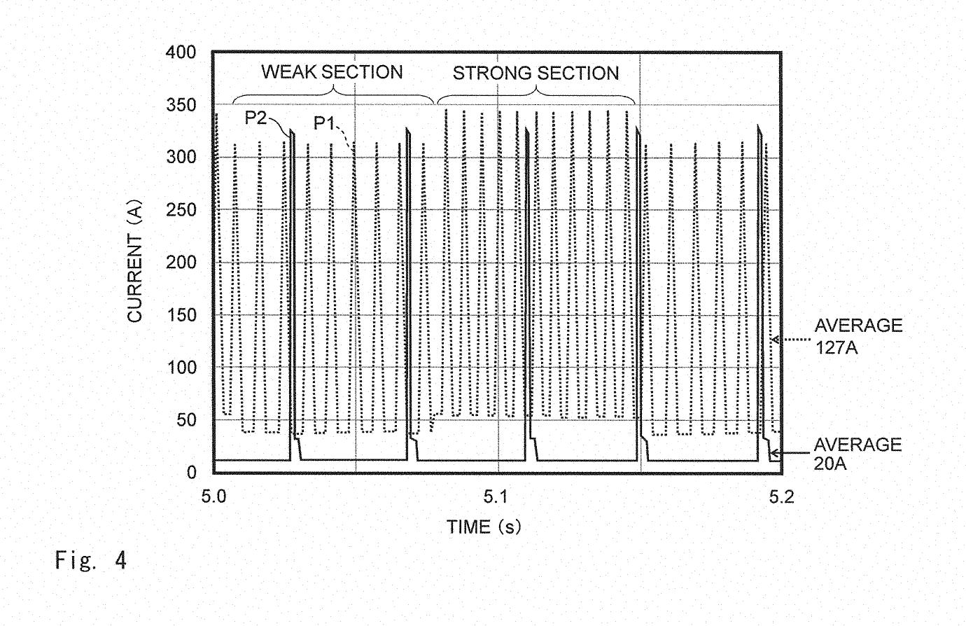

FIG. 4 is a timing chart showing the pulsed current P1 supplied to the electrode wire 13 and the pulsed current P2 supplied to the electrode wire 23 in the Example. The horizontal axis in FIG. 4 indicates time (s) and the vertical axis in FIG. 4 indicates a current (A). As shown in FIG. 4, the pulsed current P1 that has been supplied to the main torch 10 is a DC low-frequency superimposed pulse including a weak section and a strong section. By using the low-frequency superimposed pulse, the arc pressure fluctuates and the molten pool 41 oscillates, which promotes the air bubbles to be discharged.

As shown in FIG. 4, the pulsed current P2 supplied to the electrode wire 23 of the sub torch 20 was made to be asynchronous with the pulsed current P1 supplied to the electrode wire 13 of the main torch 10. The frequency of the pulsed current P1 was 124.0 Hz in the weak section and was 158.7 Hz in the strong section. The frequency of the pulsed current P2 was 24.4 Hz.

### Test Results

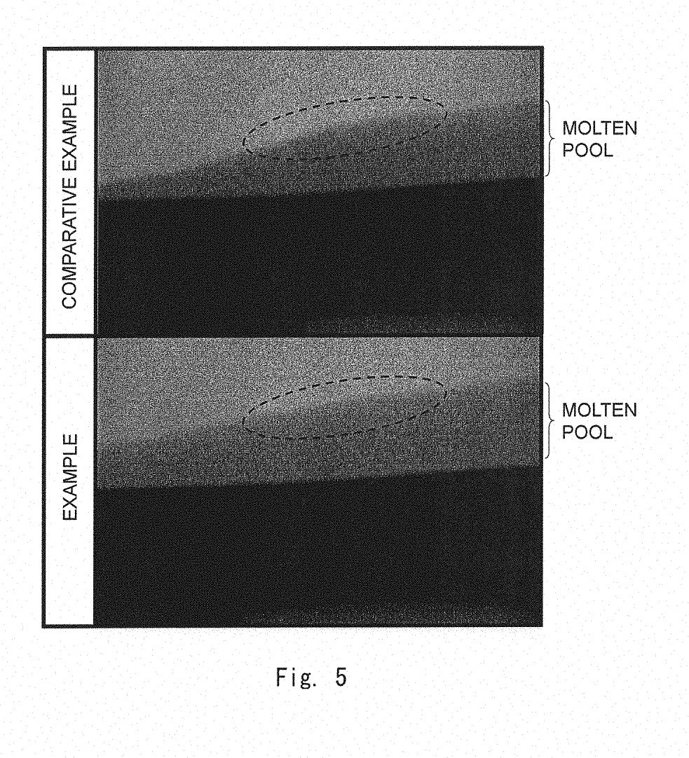

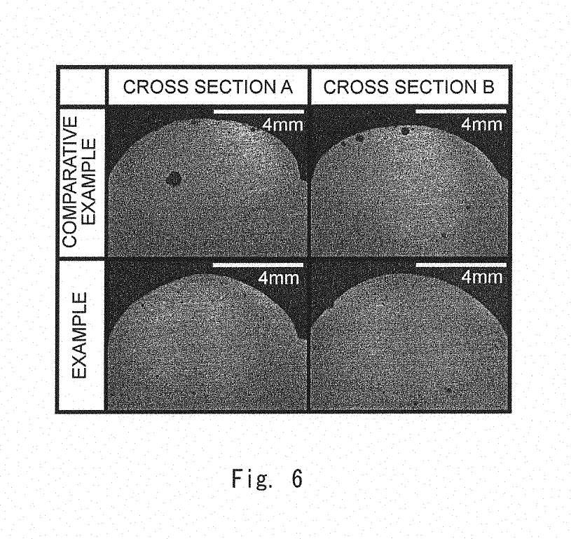

Referring next to FIGS. 5 and 6, test results according to the comparative example and the Example will be explained. FIG. 5 shows X-ray transmission images showing generation status of air bubbles in the molten pool 41 during welding. FIG. 6 shows macro photographs showing generation status of blowholes in the cross sections A and B of the welded specimen shown in FIG. 3. As shown in FIG. 5, it has been confirmed from the recorded moving image that the occurrence of the air bubbles that have been generated in the vicinity of the surface of the molten pool 41 surrounded by the dashed oval was reduced more in the Example than in the comparative example. Further, as shown in FIG. 6, in both of the cross sections A and B of the welded specimens, blowholes were reduced more in the Example than in the comparative example. As described above, in the Example, by generating the arc from the sub torch 20 at a timing different from the timing when the arc is generated from the main torch 10 on the back side of the molten pool 41, air bubbles trapped in the vicinity of the surface of the molten pool 41 in the comparative example were successfully ruptured, as shown in FIG. 5. It is therefore estimated that gas which causes blowholes was discharged from the molten pool 41 and blowholes were successfully reduced, as shown in FIG. 6.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A pulsed arc welding method in which a pulsed current is supplied to a welding electrode and welding is performed while the welding electrode is relatively moved with respect to a workpiece, wherein
the welding electrode comprises a main electrode and a sub electrode,
the sub electrode is arranged on the back side of the main electrode in the moving direction and the sub electrode is moved along with the main electrode above a molten pool formed by the main electrode, and
a second pulsed current asynchronous with a first pulsed current to be supplied to the main electrode is supplied to the sub electrode.

2. The pulsed arc welding method according to claim 1, wherein each of the main electrode and the sub electrode is a consumable welding electrode.

3. The pulsed arc welding method according to claim 1, wherein the main electrode is a consumable welding electrode and the sub electrode is a non-consumable welding electrode.

4. The pulsed arc welding method according to claim 1, wherein the workpiece comprises a die-cast member made of aluminum alloy.
